(19) United States
(12) Patent Application Publication
(10) Pub. No.: US 2025/0168284 A1
(43) Pub. Date: May 22, 2025

(54) IMAGE READING DEVICE

(71) Applicant: SHARP KABUSHIKI KAISHA, Sakai City (JP)

(72) Inventors: RISA SUZUKI, Sakai City (JP); Takashi Yamanaka, Sakai City (JP); Kohji Katamoto, Sakai City (JP); Katsutoshi Ishikawa, Sakai City (JP); Miho Yamamura, Sakai City (JP); Shizuka Bun, Sakai City (JP); Megumi Ido, Sakai City (JP); Masao Saeda, Sakai City (JP)

(21) Appl. No.: 18/953,377

(22) Filed: Nov. 20, 2024

(30) Foreign Application Priority Data
Nov. 21, 2023 (JP) 2023-197114

(51) Int. Cl. H04N 1/00

(52) U.S. Cl. CPC H04N 1/00482; H04N 1/00411; H04N 2201/0094

(57) ABSTRACT

According to an embodiment, an image reading device includes: an image reader which reads an image in accordance with setting contents of a plurality setting items; an operation receiver; a display; and a controller. The controller automatically sets, when a first operation is performed on the operation receiver, the setting contents of least one of the setting items; allows, when a second operation is performed on the operation receiver, the setting contents of the automatically set setting item to be changed by manual setting; and causes the display to notify that the setting contents of the automatically set setting item are changed by the manual setting.

### CROSS-REFERENCE TO RELATED APPLICATION

The present application claims priority from Japanese Application No. 2023-197114, filed on Nov. 21, 2023, the contents of which are hereby incorporated by reference into this application.

### BACKGROUND

### 1. Field

The present disclosure relates to an image reading device.

### 2. Description of the Related Art

A conventional technology discloses an image forming apparatus. The image forming apparatus has an APS function of detecting the size of a document, an ADS function of detecting the density of the document, and an ACS function of detecting the color of the document. In the image forming apparatus, the initial screen of an operation receiver displays a density setting display for setting the density of an image to be printed, a color setting display for setting the color of the image, a size setting display for setting the size of paper on which the image is to be formed, and an automatic mode display for activating all of the APS, ACS, and ADS functions. When the automatic mode display is pressed, a main controller performs control to clear the density setting display, the color setting display, and the size setting display from a display screen of the operation receiver.

### SUMMARY

In the image forming apparatus disclosed in the conventional technology, for example, when the automatic mode display is pressed after some of the setting contents of the density, color, and paper size have been manually set, the manually set setting contents are ignored, and the setting contents of all of the density, color, and paper size will be automatically set. Therefore, it is not possible to easily perform semi-automatic setting of manually setting the setting contents of some of setting items and causing the setting contents of the remaining setting items to be automatically set.

One aspect of the present disclosure has been conceived in light of the above problem. An object of one aspect of the present disclosure is to provide an image reading device capable of easily performing semi-automatic setting of manually setting the setting contents of at least one setting item and causing the setting contents of the remaining setting items to be automatically set.

An image reading device according to one embodiment of the present disclosure is provided with: an image reader which reads an image in accordance with setting contents of a plurality setting items; an operation receiver; a display; and a controller, in which the controller: automatically sets, when a first operation which instructs that setting contents of at least one setting item among the setting contents of the plurality of setting items be automatically set is performed on the operation receiver, the setting contents of the at least one setting item; allows, when a second operation to manually set the setting contents of the automatically set setting item is performed on the operation receiver, the setting contents of the automatically set setting item to be changed by manual setting; and causes, when the setting contents of the automatically set setting item are changed by the manual setting, the display to notify that the setting contents of the automatically set setting item are changed by the manual setting.

### BRIEF DESCRIPTION OF THE DRAWINGS

FIG. 1 is a block diagram showing an example of the structure of a multifunction peripheral according to a first embodiment.

FIG. 2A is a table showing an example of options of setting contents of a plurality of setting items.

FIG. 2B is a table showing an example of default setting contents of a setting item.

FIG. 2C is a table showing an example of setting contents for automatic setting of a plurality of setting items.

FIG. 3 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 4 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 5 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 6 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 7 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 8 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image.

FIG. 9 is a flowchart showing an example of a flow of processing performed by a controller, which is provided in a multifunction peripheral of the first embodiment, when the controller causes an image reader provided in the multifunction peripheral to read an image.

FIG. 10 is a flowchart showing an example of a flow of processing performed by a controller, which is provided in a multifunction peripheral of the first embodiment, when the controller causes an image reader provided in the multifunction peripheral to read an image.

FIG. 11 is a flowchart showing an example of a flow of processing performed by a controller, which is provided in a multifunction peripheral of the first embodiment, when the controller causes an image reader provided in the multifunction peripheral to read an image.

FIG. 12 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image after storing setting contents that have been manually set in a semi-automatic way.

FIG. 13 is a diagram illustrating an example of a transition of a screen that a controller, which is provided in a multifunction peripheral of the first embodiment, causes a touch panel display provided in the multifunction peripheral to display when the controller causes an image reader provided in the multifunction peripheral to read an image after storing setting contents that have been manually set in a semi-automatic way.

FIG. 14 is a flowchart showing an example of a flow of processing performed by a controller, which is provided in a multifunction peripheral of the first embodiment, when the controller causes an image reader provided in the multifunction peripheral to read an image after storing setting contents that have been manually set in a semi-automatic way.

FIG. 15 is a flowchart showing an example of a flow of processing performed by a controller, which is provided in a multifunction peripheral of the first embodiment, when the controller causes an image reader provided in the multifunction peripheral to read an image after storing setting contents that have been manually set in a semi-automatic way.

FIG. 16 is a diagram illustrating an example of a transition of a screen that a controller, which is provided in a multifunction peripheral of the first embodiment, causes a touch panel display provided in the multifunction peripheral to display when the controller manually sets setting contents of “document” after manually setting the setting contents of “resolution” in a semi-automatic way.

FIG. 17 is a diagram illustrating an example of a transition of a screen that a controller, which is provided in a multifunction peripheral of the first embodiment, causes a touch panel display provided in the multifunction peripheral to display when the controller manually sets setting contents of “document” after manually setting the setting contents of “resolution” in a semi-automatic way.

FIG. 18 is a diagram illustrating an example of a transition of a screen that a controller, which is provided in a multifunction peripheral of the first embodiment, causes a touch panel display provided in the multifunction peripheral to display when the controller manually sets setting contents of “document” after manually setting the setting contents of “resolution” in a semi-automatic way.

### DETAILED DESCRIPTION OF THE DISCLOSURE

### First Embodiment

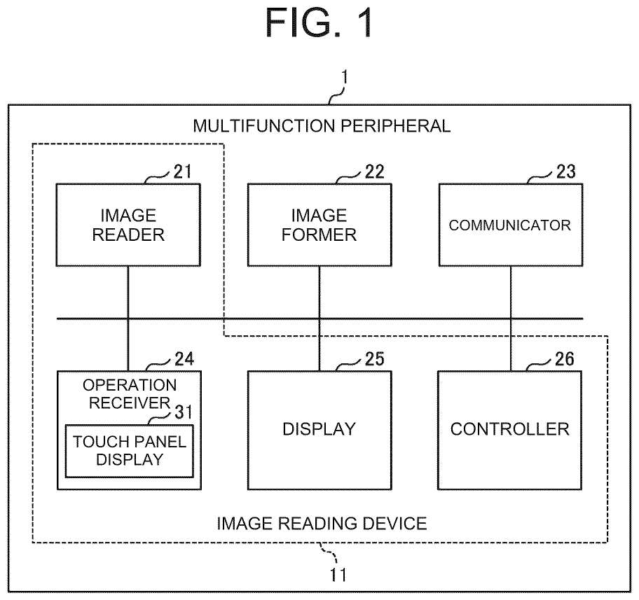

A first embodiment will be described with reference to FIGS. 1 to 18. In the drawings, the same or similar elements are denoted by the same reference numerals, and redundant description thereof will be omitted.

FIG. 1 is a block diagram showing an example of the structure of a multifunction peripheral (MFP) according to the first embodiment.

A multifunction peripheral 1 illustrated in FIG. 1 includes a copy mode, a print mode, a fax mode, and a scan mode. Therefore, the multifunction peripheral 1 incorporates therein an image reading device 11 required for the copy mode, the fax mode, and the scan mode. The image reading device 11 may be incorporated in a dedicated copy machine, a dedicated fax machine, or a dedicated scanner machine.

The multifunction peripheral 1 is provided with an image reader 21, an image former 22, a communicator 23, an operation receiver 24, a display 25, and a controller 26. The image reader 21, the operation receiver 24, the display 25, and the controller 26 constitute the image reading device 11.

The image reader 21 reads an image on a document in accordance with setting contents of a plurality of setting items, and generates image data corresponding to the read image. The image reader 21 includes an automatic document feeder (ADF), a document reader, a document placement table, and a reading device. In a case where the image reader 21 reads an image on a document by an ADF method, the ADF sends, to the document reader, each document included in a plurality of documents set to the ADF, and the reading device reads the image on each of the documents sent to the document reader. In a case where the image reader 21 reads an image on a document by a flatbed method, a reading mechanism reads the image on the document set on the document placement table.

The image former 22 forms an image corresponding to image data on a sheet of paper. The image former 22 forms an image on a sheet of paper by, for example, an electrophotographic method, an inkjet method, or a thermosensitive method.

The communicator 23 is connected to a public switched telephone network and a network. The communicator 23 transmits a fax signal corresponding to image data to a fax machine connected to the public switched telephone network. The communicator 23 receives a fax signal corresponding to image data from a fax machine connected to the public switched telephone network, and acquires the image data from the received fax signal. The communicator 23 transmits image data to a device connected to the network. The communicator 23 receives image data from a device connected to the network.

The operation receiver 24 receives an operation.

As illustrated in FIG. 1, the operation receiver 24 is provided with a touch panel display 31. The touch panel display also serves as the display 25. The operation receiver 24 may be provided with an operation member other than the touch panel display 31. For example, the operation receiver 24 may be provided with a button, a lever, a dial, a slider, and the like.

The plurality of setting items include the items “document”, “resolution”, and “blank page skipping”. Therefore, the setting contents of the plurality of setting items include setting contents of the “document”, the “resolution”, and the “blank page skipping”.

The setting contents of the “document” include the size of a document, the orientation of the document, whether to read an image on both sides of the document or only one side of the document, and the orientation of the image on the document. The setting contents of the “document” may include items other than those indicated above.

The setting contents of the “resolution” include a resolution in a main scanning direction and a resolution in the sub-scanning direction. The setting contents of the “resolution” may include items other than those indicated above.

The setting contents of the “blank page skipping” include whether to skip a blank document and to read an image on a document other than the blank document. The setting contents of the “blank page skipping” may include items other than the above item.

The plurality of setting items may include setting items other than the “document”, the “resolution”, and the “blank page skipping”. Therefore, the setting contents of the plurality of setting items may include setting contents of a setting item other than the “document”, the “resolution”, and the “blank page skipping”. For example, the plurality of setting items may include items such as “monochrome”, “document tilt correction”, “compression ratio”, and the like. Therefore, the setting contents of the plurality of setting items may include the setting contents of the items “monochrome”, “document tilt correction”, “compression ratio”, and the like.

The setting contents of the “monochrome” indicate whether the image on the document is read in black-and-white binary or grayscale.

The setting contents of the “document tilt correction” indicate whether to correct a tilted state of the document or a tilted state of the image on the document.

The setting contents of the “compression ratio” indicate the compression ratio of the image data to be generated.

The display 25 displays a screen. The display 25 is provided with, for example, a liquid crystal display, an organic light-emitting diode (OLED) display, a quantum dot light-emitting diode (QLED) display, and the like.

The controller 26 controls the image reader 21, the image former 22, the communicator 23, the operation receiver 24, and the display 25.

The controller 26 is provided with a processor, a memory, a storage, and a peripheral circuit. The storage stores programs. The processor executes the program loaded from the storage into the memory and causes the processor, the memory, the storage and the peripheral circuit to be operated as the controller 26. Some of or all of the processing performed by the processor may be performed by a dedicated electronic circuit.

When the multifunction peripheral 1 is in a copy mode, the controller 26 causes the image reader 21 to read an image on a document in accordance with the setting contents of a plurality of setting items and to generate image data corresponding to the read image. Further, the controller 26 causes the image former 22 to form an image corresponding to the generated image data on a sheet of paper.

When the multifunction peripheral 1 is in a print mode, the controller 26 causes the communicator 23 to receive image data. Further, the controller 26 causes the image former 22 to form an image corresponding to the received image data.

When the multifunction peripheral 1 is in a fax mode and fax transmission is performed, the controller 26 causes the image reader 21 to read an image on a document in accordance with the setting contents of a plurality of setting items and to generate image data corresponding to the read image. Further, the controller 26 causes the communicator 23 to transmit a fax signal corresponding to the generated image data to a fax machine connected to the public switched telephone network.

When the multifunction peripheral 1 is in a fax mode and fax reception is performed, the controller 26 causes the communicator 23 to receive a fax signal corresponding to image data from a fax machine connected to the public switched telephone network, and to acquire the image data from the received signal. Further, the controller 26 causes the image former 22 to form an image corresponding to the acquired image data on a sheet of paper.

When the multifunction peripheral 1 is in a scan mode, the controller 26 causes the image reader 21 to read an image on a document in accordance with the setting contents of a plurality of setting items and to generate image data corresponding to the read image. Further, the controller 26 causes the communicator 23 to transmit the generated image data to a device connected to the network.

When a first operation which instructs that the setting contents of at least one setting item among the setting contents of the plurality of setting items should be automatically set is performed on the operation receiver 24, the controller 26 causes the setting contents of the at least one setting item to be automatically set. Further, when a second operation to manually set the setting contents of the automatically set setting item is performed on the operation receiver 24, the controller 26 allows the setting contents of the automatically set setting item to be changed by the manual setting. Specifically, when a third operation, which instructs that manual setting should be started for an object to be operated indicating the automatically set setting item, is performed on the touch panel display 31, the controller 26 allows the second operation to be received on the touch panel display 31. Further, when the setting contents of the automatically set setting item are changed by the manual setting, the controller 26 causes the display 25 to notify that the setting contents of the automatically set setting item are changed by the manual setting.

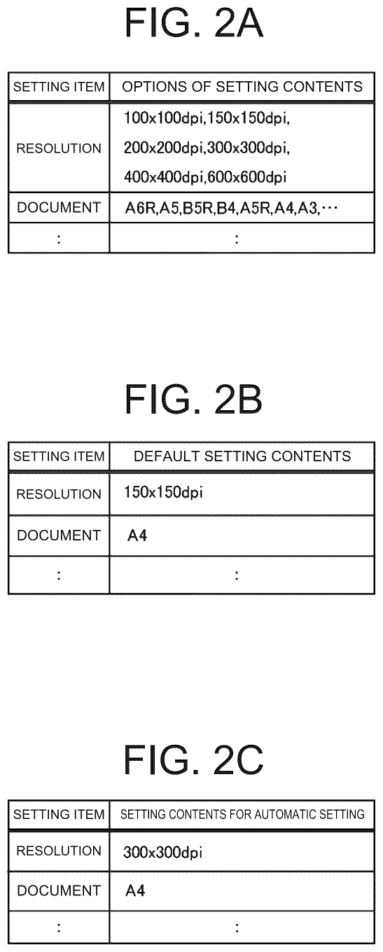

FIG. 2A is a table showing an example of options of the setting contents of the plurality of setting items. FIG. 2B is a table showing an example of default setting contents of the plurality of setting items. FIG. 2C is a table showing an example of the setting contents for automatic setting of the plurality of setting items.

The controller 26 stores a plurality of options of the setting contents for each of the setting items included in the plurality of setting items. The controller 26 selects the setting contents of each of the setting items from the plurality of options of the setting contents stored for each setting item. For example, as illustrated in FIG. 2A, the controller 26 stores a plurality of options of the setting contents, which are “100×100 dpi”, “150×150 dpi”, “200×200 dpi”, “300×300 dpi”, “400×400 dpi”, and “600×600 dpi”, for “resolution”. The controller 26 selects the setting contents for “resolution” from the plurality of options “100×100 dpi”, “150×150 dpi”, “200×200 dpi”, “300×300 dpi”, “400×400 dpi”, and “600×600 dpi” of the setting contents. In addition, the controller 26 stores a plurality of options of the setting contents, which are “A6R”, “A5”, “B5R”, “B4”, “A5R”, “A4”, “A3”, . . . , for “document”. The controller 26 selects the setting contents for “document” from the plurality of options “A6R”, “A5”, “B5R”, “B4”, “A5R”, “A4”, “A3”, . . . , of the setting contents.

The controller 26 stores the default setting contents for each of the setting items included in the plurality of setting items. The controller 26 causes, when the multifunction peripheral 1 is started, the setting contents of each of the setting items to be the default setting contents stored for each setting item. The controller 26 maintains the state in which the setting contents of each of the setting items are set to the default setting contents except for the case where the first operation is performed and the case where the second operation is performed. For example, as illustrated in FIG. 2B, the controller 26 stores the default setting contents “150×150 dpi” for “resolution”. The controller 26 causes, when the multifunction peripheral 1 is started, the setting contents of the “resolution” to be the default setting contents “150×150 dpi” stored for the “resolution”. The controller 26 maintains the state in which the setting contents of the “resolution” are set to “150×150 dpi”, which is the default setting contents, except for the case where the first operation, which instructs that the setting contents of the “resolution” should be automatically set, is performed, and the case where the second operation to manually set the setting contents of the “resolution” to, for example, “200×200 dpi”, which is the setting contents different from the automatically set setting contents, is performed. In addition, the controller 26 stores the default setting contents “A4” for “document”. The controller 26 causes, when the multifunction peripheral 1 is started, the setting contents of the “document” to be the default setting contents “A4” stored for the “document”. The controller 26 maintains the state in which the setting contents of the “document” are set to “A4”, which is the default setting contents, except for the case where the first operation, which instructs that the setting contents of the “document” should be automatically set, is performed, and the case where the second operation to manually set the setting contents of the “document” to, for example, “A3”, which is the setting contents different from the automatically set setting contents, is performed.

The controller 26 stores the setting contents for automatic setting for each of the setting items included in the plurality of setting items. When automatic setting is to be performed for the setting contents of each of the setting items, the controller 26 forcibly changes the setting contents of each of the setting items to the setting contents for automatic setting stored for each setting item. The controller 26 stores the setting contents for automatic setting separately from the default setting contents stored for each of the setting items. Therefore, the setting contents for automatic setting stored for each setting item may be the same as the default setting contents stored for each setting item, or may be different from the default setting contents stored for each setting item. For example, as illustrated in FIG. 2C, the controller 26 stores “300×300 dpi” as the setting contents for automatic setting for “resolution”. When automatic setting is performed for the setting contents of the “resolution”, the controller 26 forcibly changes the setting contents of the “resolution” to “300×300 dpi”, which is the setting contents for automatic setting stored for the “resolution”. In addition, the controller 26 stores “A4” as the setting contents for automatic setting for “document.” When automatic setting is performed for the setting contents of the “document”, the controller 26 forcibly changes the setting contents of the “document” to “A4”, which is the setting contents for automatic setting stored for the “document”. The setting contents for automatic setting of the resolution, for example, may be those set on the basis of image data generated by the image reader 21 as the image reader 21 reads the image on a document set on the document placement table.

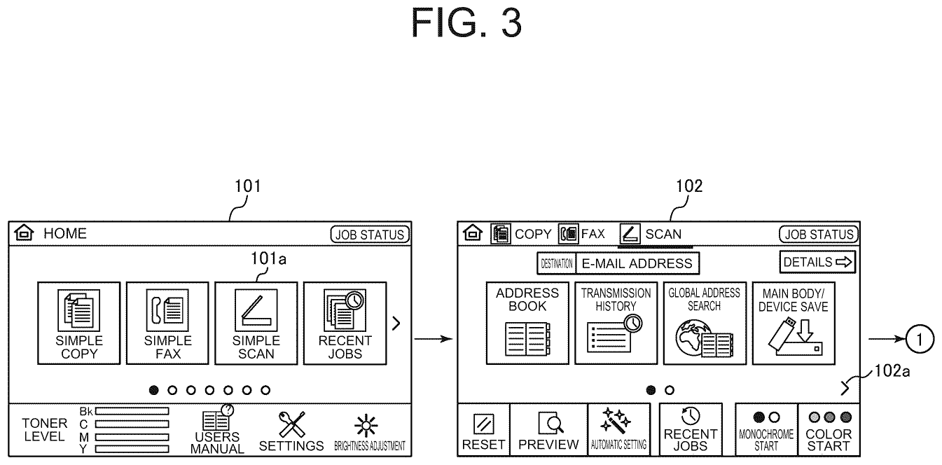

FIGS. 3 to 8 are diagrams illustrating an example of a transition of a screen that the controller 26 causes the touch panel display 31 to display when the controller 26 causes the image reader 21 to read an image.

The controller 26 causes the touch panel display 31 to display a home screen 101 as illustrated on the left side of FIG. 3. The home screen 101 is used for an operation to select the mode of the multifunction peripheral 1. The home screen 101 includes a simple scan button 101a.

When an operation to press the simple scan button 101a is performed on the touch panel display 31, as illustrated on the right side of FIG. 3, the controller 26 ends the display of the home screen 101 on the touch panel display 31 and causes the touch panel display 31 to display a destination selection screen 102 of the scan mode. The destination selection screen 102 of the scan mode is used for an operation to select the destination to which the image data is to be transmitted. The destination selection screen 102 of the scan mode includes a switching button 102a.

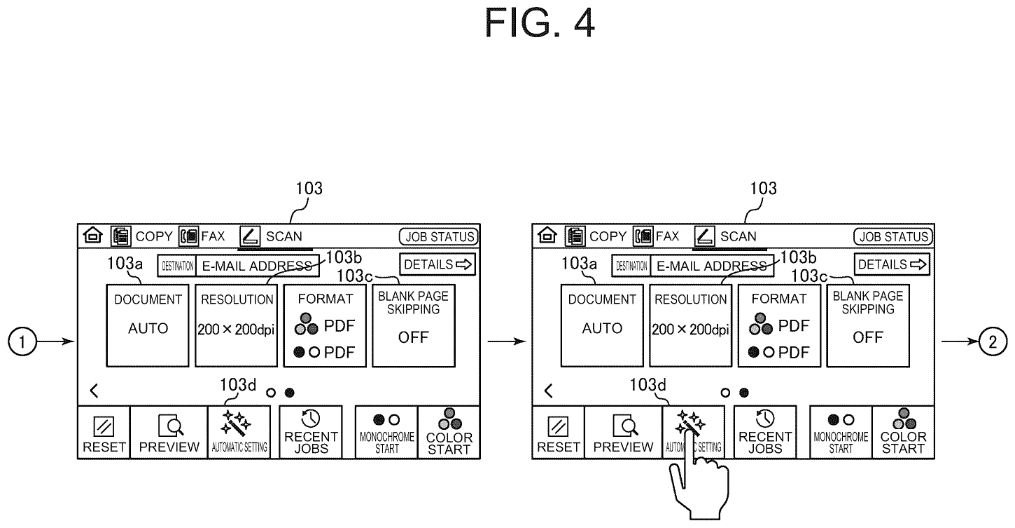

When an operation to press the switching button 102a is performed on the touch panel display 31, as illustrated on the left side of FIG. 4, the controller 26 ends the display of the destination selection screen 102 of the scan mode and causes a setting screen 103 of the scan mode to be displayed on the touch panel display 31. The setting screen 103 of the scan mode is used for an operation to select “document”, “resolution” or “blank page skipping,” and an operation to instruct that automatic setting should be performed for the setting contents of the “document”, the “resolution”, the “blank page skipping”, and the like. The setting screen 103 of the scan mode includes a document button 103a, a resolution button 103b, a blank page skipping button 103c, and an automatic setting button 103d. At this point, the controller 26 causes the setting contents of the “document”, the “resolution”, and the “blank page skipping” to be the default setting contents, which are “Auto”, “200×200 dpi”, and “Off”, respectively. Therefore, the controller 26 displays the character strings “Auto”, “200×200 dpi”, and “Off” indicating the default setting contents “Auto”, “200×200 dpi”, and “Off”, which are the setting contents of the “document”, the “resolution”, and the “blank page skipping” at this point, on the document button 103a, the resolution button 103b, and the blank page skipping button 103c, respectively.

The document button 103a, the resolution button 103b, and the blank page skipping button 103c are examples of selection buttons via which the operation to select the setting item is performed. The automatic setting button 103d is an example of an object to be operated on which an operation to instruct that the setting contents of the “resolution” and the “blank page skipping”, etc., should be automatically set is performed. The operation of pressing the automatic setting button 103d is an example of the first operation.

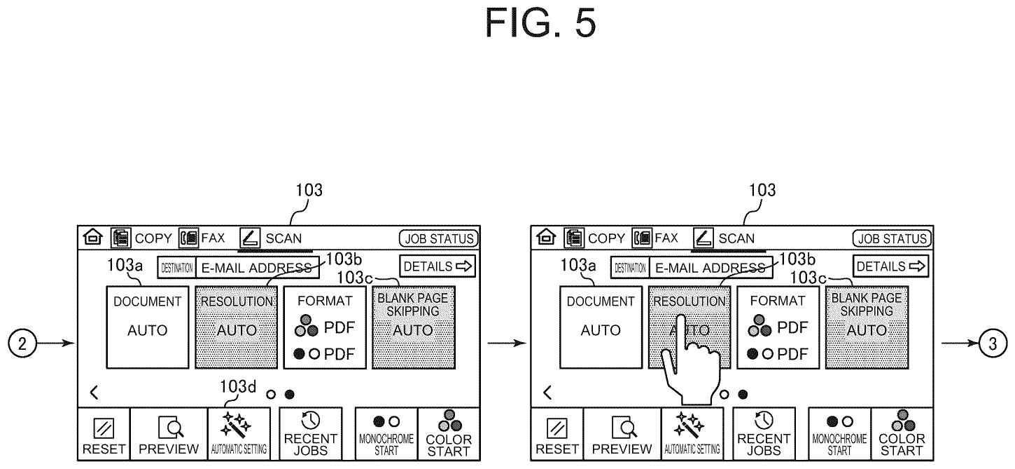

When an operation to press the automatic setting button 103d is performed on the touch panel display 31 as illustrated on the right side of FIG. 4, the controller 26 changes the display forms of the resolution button 103b and the blank page skipping button 103c from a normal display form to a display form indicating that the setting contents of the “resolution” and the “blank page skipping” are brought into the state of the automatically set setting contents. For example, the controller 26 causes the display 25 to display a screen element indicating that automatic setting has been performed. The screen element indicating that automatic setting has been performed is indicated by changing, for example, the brightness, the color, the shape, the character string, or the like. For example, as illustrated on the left side of FIG. 5, the controller 26 grays out and displays the resolution button 103b and the blank page skipping button 103c to indicate that automatic setting has been performed for the setting contents of the “resolution” and the “blank page skipping”. In other words, when automatic setting is performed for the setting contents of at least one setting item, the controller 26 changes the display form of the object to be operated indicating the automatically set setting item. Further, as illustrated on the left side of FIG. 5, the controller 26 causes the resolution button 103b and the blank page skipping button 103c to display the character string “Auto” indicating that the automatic setting has been performed for the setting contents of the “resolution” and the “blank page skipping”.

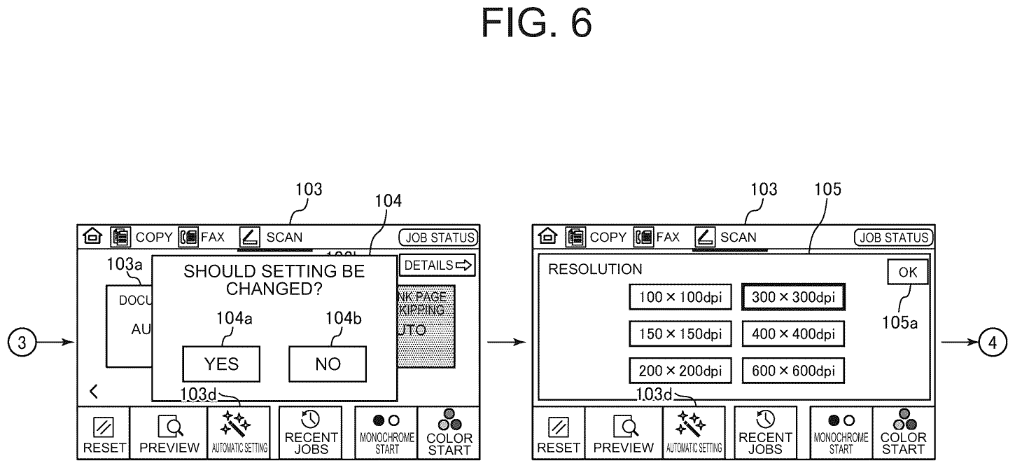

As illustrated on the right side of FIG. 5, when an operation to press the resolution button 103b is performed, the controller 26 displays, as indicated on the left side of FIG. 6, a screen 104 on the touch panel display 31 such that the screen 104 overlaps the setting screen 103 of the scan mode. That is, for example, the operation of pressing the resolution button 103b after the controller 26 has performed the automatic setting for the setting contents of “resolution” is an example of the third operation. The screen 104 makes an inquiry about whether or not to perform manual setting for the setting contents of the “resolution” by changing the automatically set setting contents of the “resolution”. The screen 104 includes a YES button 104a and a NO button 104b. Note that the operation of pressing the resolution button 103b via which the above-mentioned setting change is received may receive the setting change only when a specific operation, such as a “long press” or a “double-click”, is received.

When an operation of pressing the YES button 104a is performed on the touch panel display 31, as illustrated on the right side of FIG. 6, the controller 26 causes the touch panel display 31 to display a setting screen 105 of the “resolution” such that the setting screen 105 overlaps the setting screen 103 of the scan mode, and the setting screen 105 of the “resolution” includes an OK button 105a. An operation on the setting screen 105 is an example of the second operation.

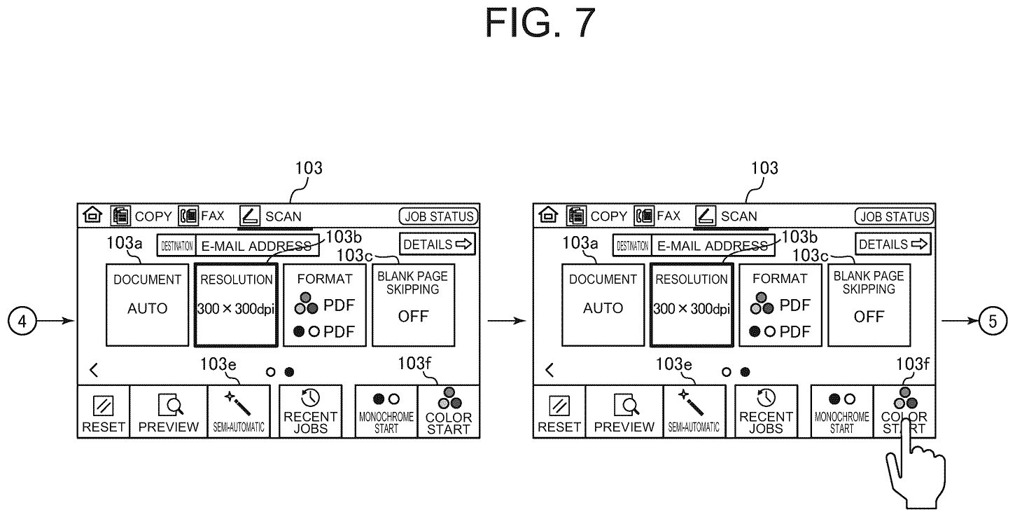

After an operation has been performed on the touch panel display 31 so that the setting contents of the “resolution” are manually set and the setting contents of the “resolution” are set to “300×300 dpi” as the resolution, when an operation to press the OK button 105a is performed on the touch panel display 31, as illustrated on the left side of FIG. 7, the controller 26 ends the display of the setting screen 105 of the “resolution” on the touch panel display 31, sets the setting contents of the “resolution” to “300×300 dpi”, and updates the setting screen 103 of the scan mode. In doing so, the controller 26 causes the resolution button 103b to display the character string “300×300 dpi” indicating the resolution “300×300 dpi”.

Further, as the controller 26 causes the touch panel display 31 to display a screen element indicating that the setting contents of the “document”, the “resolution”, and the “blank page skipping” have been manually set in a semi-automatic way, such as a semi-auto button 103e, the user can easily recognize that the setting contents of the “document”, the “resolution”, and the “blank page skipping” have been manually set in a semi-automatic way. In addition, as the controller 26 causes the touch panel display 31 to display the semi-auto button 103e, the user can easily recognize that the setting contents of the “document”, the “resolution”, and the “blank page skipping” have been manually set in a semi-automatic way.

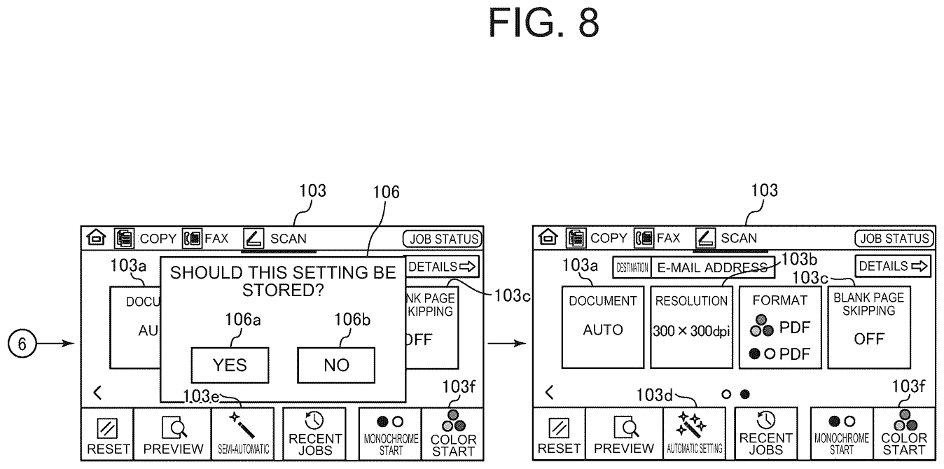

When an operation to press a scan start button 103f is performed on the touch panel display 31, as illustrated on the right side of FIG. 7, the controller 26 causes, as illustrated on the left side of FIG. 8, the touch panel display 31 to display a screen 106 such that the screen 106 overlaps the setting screen 103 of the scan mode. The screen 106 makes an inquiry about whether or not to store the resolution “300×300 dpi”. The screen 106 includes a YES button 106a and a NO button 106b.

When an operation to press the YES button 106a is performed on the touch panel display 31, the controller 26 stores the resolution “300×300 dpi” and ends the display of the screen 106 on the touch panel display 31 as illustrated on the right side of FIG. 8.

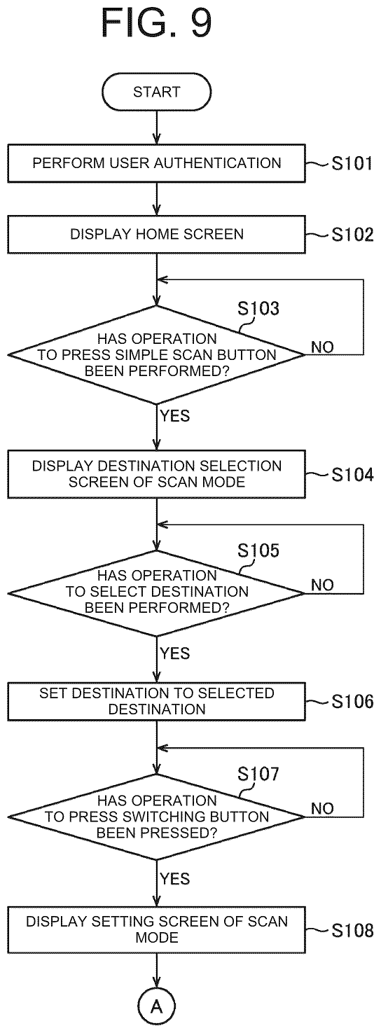

FIGS. 9 to 11 are flowcharts showing an example of a flow of processing performed by the controller 26 in a case where the controller 26 provided in the multifunction peripheral 1 according to the present embodiment causes the image reader 21 to read an image.

In step S101, the controller 26 performs user authentication. In this way, the controller 26 identifies the user who uses the multifunction peripheral 1. The controller 26 performs the user authentication on the basis of a user number input by an operation performed on the operation receiver 24. Alternatively, the controller 26 performs the user authentication on the basis of a login name and a password input by an operation performed on the operation receiver 24. Alternatively, in a case where the multifunction peripheral 1 is provided with an integrated circuit (IC) card reader, the controller 26 performs the user authentication on the basis of data read from an IC card by the IC card reader. An administrator of the multifunction peripheral 1 can make the setting of the functional contents of the multifunction peripheral 1 and can make the setting of the automatic setting for each user.

In step S102, the controller 26 causes the touch panel display 31 to display the home screen 101.

In step S103, the controller 26 determines whether or not an operation to press the simple scan button 101a has been performed on the touch panel display 31. If the controller 26 determines that no such operation has been performed on the touch panel display 31, the controller 26 executes step S103 again. Meanwhile, if the controller 26 determines that such an operation has been performed on the touch panel display 31, the controller 26 executes step S104.

In step S104, the controller 26 ends the display of the home screen 101 on the touch panel display 31, and causes the touch panel display 31 to display the destination selection screen 102 of the scan mode.

Through steps S103 and S104, the controller 26 waits until the simple scan button 101a is pressed, and in response to the pressing of the simple scan button 101a, the controller 26 switches the screen to be displayed on the touch panel display 31 from the home screen 101 to the destination selection screen 102 of the scan mode.

In step S105, the controller 26 determines whether or not an operation to select the destination has been performed on the touch panel display 31. If it is determined that no such operation has been performed on the touch panel display 31, the controller 26 executes step S105 again. Meanwhile, if it is determined that such an operation has been performed on the touch panel display 31, the controller 26 executes step S106.

In step S106, the controller 26 sets the destination to the selected destination.

Through steps S105 and S106, the controller 26 waits until the destination is selected, and in response to the selection of the destination, the controller 26 sets the destination to the selected destination.

In step S107, the controller 26 determines whether or not an operation to press the switching button 102a has been performed on the touch panel display 31. If it is determined that no such operation has been performed on the touch panel display 31, the controller 26 executes step S107 again. Meanwhile, if it is determined that such an operation has been performed on the touch panel display 31, the controller 26 executes step S108.

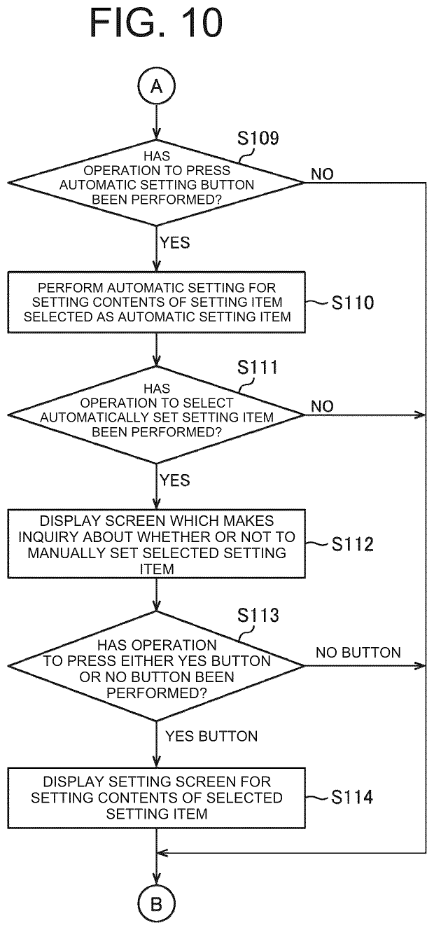

In step S108, the controller 26 ends the display of the destination selection screen 102 of the scan mode on the touch panel display 31, and causes the touch panel display 31 to display the setting screen 103 of the scan mode. Then, the controller 26 executes step S109 exemplified in FIG. 10.

FIG. 10 is a flowchart showing an example of a flow of processing performed by the controller 26 subsequent to FIG. 9.

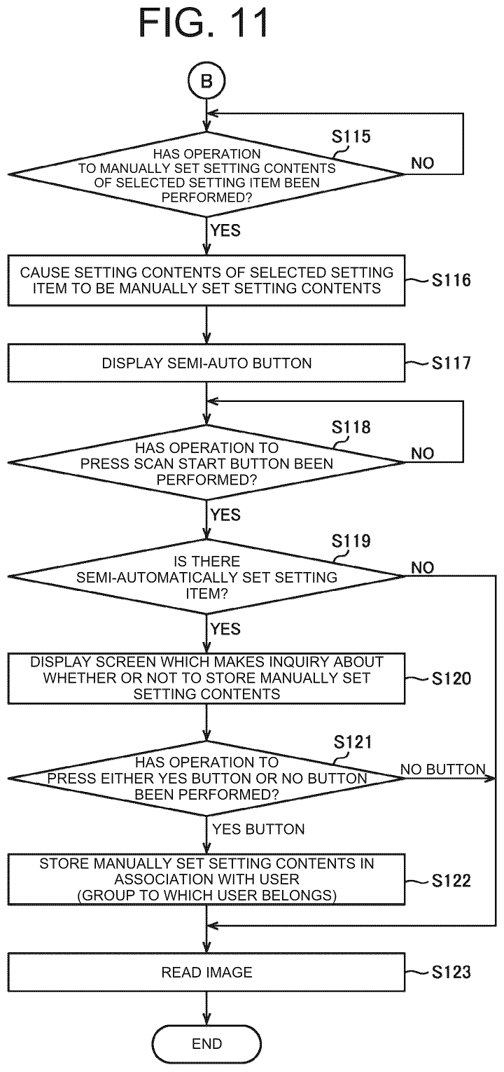

In step S109, the controller 26 determines whether or not an operation to press the automatic setting button 103d has been performed on the touch panel display 31. If it is determined that no such operation has been performed on the touch panel display 31, the controller 26 executes step S115 exemplified in FIG. 11. Meanwhile, if it is determined that such an operation has been performed on the touch panel display 31, the controller 26 executes step S110.

In step S110, the controller 26 performs automatic setting for the setting contents of the setting item, which has been selected as at least one automatic setting item among a plurality of setting items.

In step S111, the controller 26 determines whether or not an operation to select the automatically set setting item has been performed on the touch panel display 31. If it is determined that no such operation has been performed on the touch panel display 31, the controller 26 executes step S115 exemplified in FIG. 11. Meanwhile, if it is determined that such an operation has been performed on the touch panel display 31, the controller 26 executes step S112.

In step S112, the controller 26 causes the touch panel display 31 to display the screen 104 for making an inquiry about whether or not to change and manually set the automatically set setting contents of the selected setting item such that the screen 104 overlaps the setting screen 103 of the scan mode.

In step S113, the controller 26 determines whether or not an operation to press either the YES button 104a or the NO button 104b has been performed on the touch panel display 31. If it is determined that an operation to press the NO button 104b has been performed on the touch panel display 31, the controller 26 executes step S115 exemplified in FIG. 11. Meanwhile, if it is determined that an operation to press the YES button 104a has been performed on the touch panel display 31, the controller 26 executes step S114.

In step S114, the controller 26 causes the touch panel display 31 to display the setting screen 105 for the setting contents of the selected setting item such that the setting screen 105 overlaps the setting screen 103 of the scan mode. That is, through steps S111 to S114, when the third operation, which instructs that manual setting should be started for an object to be operated indicating the automatically set setting item, is performed on the touch panel display 31, the controller 26 allows the second operation for performing the manual setting to be received on the touch panel display 31. Then, the controller 26 executes step S115 exemplified in FIG. 11.

For example, in a case where automatic setting has been performed for the setting contents of “document” in step S110, if the document button 103a is pressed and “document” is selected in step S111, in step S114, the controller 26 causes the touch panel display 31 to display the setting screen 105 of the “document” such that the setting screen 105 overlaps the setting screen 103 of the scan mode.

Further, for example, in a case where automatic setting has been performed for the setting contents of “resolution” in step S110, if the resolution button 103b is pressed and “resolution” is selected in step S111, in step S114, the controller 26 causes the touch panel display 31 to display the setting screen 105 of the “resolution” such that the setting screen 105 overlaps the setting screen 103 of the scan mode.

Furthermore, for example, in a case where automatic setting has been performed for the setting contents of “blank page skipping” in step S110, if the blank page skipping button 103c is pressed and “blank page skipping” is selected in step S111, in step S114, the controller 26 causes the touch panel display 31 to display the setting screen 105 of the “blank page skipping” such that the setting screen 105 overlaps the setting screen 103 of the scan mode.

FIG. 11 is a flowchart showing an example of a flow of processing performed by the controller 26 subsequent to FIG. 10.

In step S115, the controller 26 determines whether or not an operation to manually set the setting contents of the selected setting item in a semi-automatic way has been performed on the touch panel display 31. If it is determined that no such operation has been performed on the touch panel display 31, the controller 26 executes step S115 again. Meanwhile, if it is determined that such an operation has been performed on the touch panel display 31, the controller 26 executes step S116.

In step S116, the controller 26 causes the setting contents of the selected setting item to be setting contents manually set in a semi-automatic way. In this way, the controller 26 can change the automatically set setting item by the manual setting. For example, when an operation to press the resolution button 103b is performed on the touch panel display 31, if a series of operations consisting of an operation to manually set the setting contents of the “resolution” in a semi-automatic way to set the setting contents of the “resolution” to “300×300 dpi” as the resolution and an operation to press the OK button 105a is performed on the touch panel display 31, the controller 26 sets the setting contents of the “resolution” to “300×300 dpi” as the resolution.

In step S117, the controller 26 ends the display of the automatic setting button 103d on the touch panel display 31 and causes the touch panel display 31 to display the semi-auto button 103e. That is, in a case where the setting contents of the automatically set setting item have been changed by the manual setting, the controller 26 causes the touch panel display 31 to notify that the setting contents of the automatically set setting item have been changed by the manual setting.

In step S118, the controller 26 determines whether or not an operation to press the scan start button 103f has been performed on the touch panel display 31. If it is determined that no such operation has been performed on the touch panel display 31, the controller 26 executes step S118 again. Meanwhile, if it is determined that such an operation has been performed on the touch panel display 31, the controller 26 executes step S119.

In step S119, the controller 26 determines whether or not there exists a setting item that has been manually set in a semi-automatic way. That is, the controller 26 determines whether or not the setting contents of the selected setting item are those that have been manually set in a semi-automatic way, and whether or not the non-selected setting item has the automatically set setting contents or default setting contents. If it is determined that there exists no setting item manually set in a semi-automatic way, the controller 26 executes step S123. Meanwhile, if the setting contents of the selected setting item are those that have been manually set, and the non-selected setting item has the automatically set setting contents or default setting contents, the controller 26 determines that there exists a setting item that has been manually set in a semi-automatic way. If it is determined that there exists a setting item manually set in a semi-automatic way, the controller 26 executes step S120.

In step S120, the controller 26 causes the touch panel display 31 to display the screen 106 such that the screen 106 overlaps the setting screen 103 of the scan mode. The screen 106 makes an inquiry about whether or not to store the setting contents that have been manually set in a semi-automatic way.

In step S121, the controller 26 determines whether an operation to press either the YES button 106a or the NO button 106b has been performed on the touch panel display 31. If it is determined that an operation to press the NO button 106b has been performed on the touch panel display 31, the controller 26 executes step S123. Meanwhile, if it is determined that an operation to press the YES button 106a has been performed on the touch panel display 31, the controller 26 executes step S122.

In step S122, the controller 26 stores the setting contents that have been manually set in a semi-automatic way in association with the user. Further, the controller 26 causes the setting contents of at least one setting item that can be automatically set to be the setting contents stored in association with the user. The stored setting contents are assumed as default setting contents. The associated user is the user involved when the second operation to manually set the setting contents of the automatically set setting item is performed on the touch panel display 31, that is, the user identified in step S101.

In step S123, the controller 26 causes the image reader 21 to read an image in accordance with the setting contents of the plurality of setting items. For example, the controller 26 causes the image reader 21 to read the image in accordance with the setting contents of the “document”, the “resolution”, and the “blank page skipping”.

Through steps S118 to S123, the controller 26 waits until the scan start button 103f is pressed. Further, in a case where the setting contents of at least one of the “document”, “resolution”, and “blank page skipping” are manually set in a semi-automatic way, the controller 26, in response to the pressing of the scan start button 103f, makes an inquiry about whether or not to store the setting contents that have been manually set in a semi-automatic way, and stores, when an instruction is given to store the setting contents that have been manually set in a semi-automatic way, the setting contents that have been manually set in a semi-automatic way. Next, the controller 26 causes the image reader 21 to read the image. Meanwhile, in a case where no semi-automatic manual setting has been performed for the setting contents of at least one of the “document”, “resolution”, and “blank page skipping”, the controller 26 causes the image reader 21 to immediately read the image in response to the pressing of the scan start button 103f.

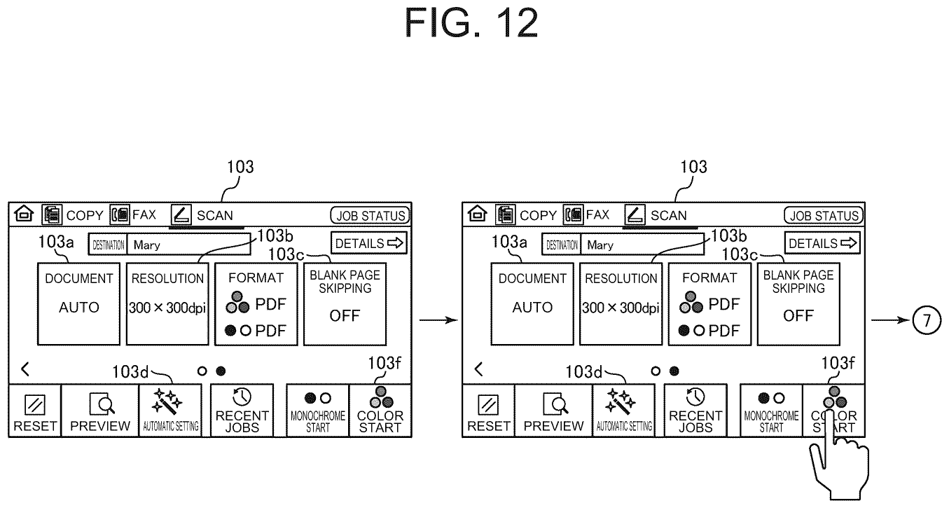

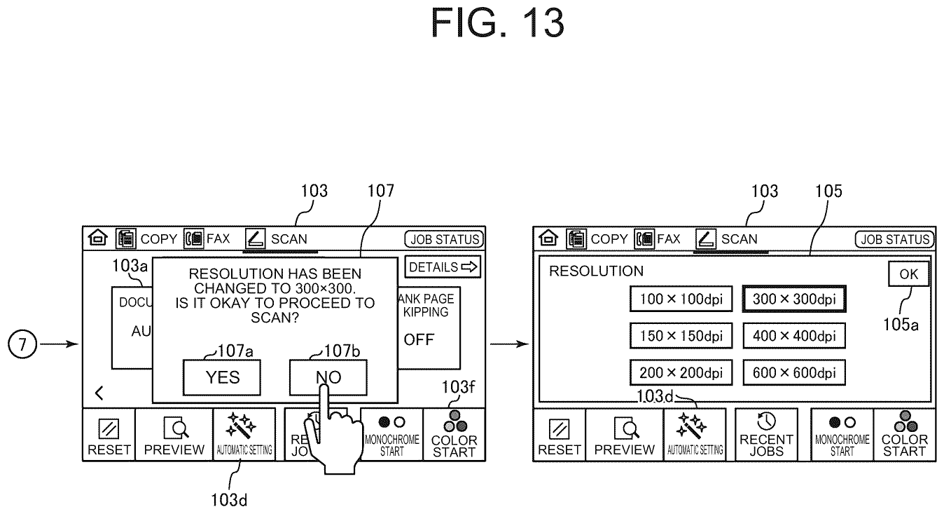

FIGS. 12 to 13 are diagrams illustrating an example of a transition of a screen that the controller 26 causes the touch panel display 31 to display when the controller 26 causes the image reader 21 to read an image after storing the setting contents that have been manually set in a semi-automatic way.

When an operation to press the simple scan button 101a indicated on the left side of FIG. 3 is performed on the touch panel display, the controller 26 causes, as illustrated on the left side of FIG. 12, the touch panel display 31 to display the setting screen 103 of the scan mode. In a case where the setting contents of the “resolution” are manually set in a semi-automatic way and the resolution “300×300 dpi” is stored, default setting contents of the “resolution” are set to the resolution “300×300 dpi”.

When an operation to press the scan start button 103f is performed on the touch panel display 31, as illustrated on the right side of FIG. 12, the controller 26 causes, as illustrated on the left side of FIG. 13, the touch panel display 31 to display a screen 107 such that the screen 107 overlaps the setting screen 103 of the scan mode. The screen 107 makes an inquiry about whether or not to read the image by using the setting contents of the “resolution” that have been manually set. The screen 107 includes a YES button 107a and a NO button 107b.

When an operation to press the NO button 107b is performed on the touch panel display 31, the controller 26 causes, as illustrated on the right side of FIG. 13, the touch panel display 31 to display the setting screen 105 of the “resolution” such that the setting screen 105 overlaps the setting screen 103 of the scan mode.

After an operation has been performed on the touch panel display 31 so that the setting contents of the “resolution” are manually set in a semi-automatic way and the setting contents of the “resolution” are set to “300×300 dpi” as the resolution, when an operation to press the OK button 105a is performed on the touch panel display 31, as illustrated on the left side of FIG. 7, the controller 26 ends the display of the setting screen 105 of the “resolution” on the touch panel display 31, sets the setting contents of the “resolution” to “300×300 dpi”, and updates the setting screen 103 of the scan mode. Since the subsequent screen transitions are the same as the transitions indicated from the left side of FIG. 7, a detailed description thereof will be omitted.

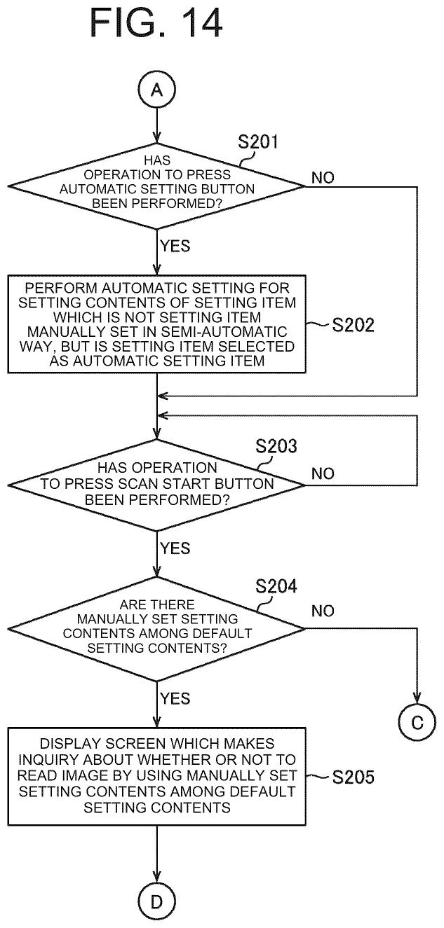

FIG. 14 is a flowchart showing an example of a flow of processing performed by the controller 26 in a case where the controller 26 causes the image reader 21 to read an image after storing the setting contents that have been manually set in a semi-automatic way. It is assumed that the controller 26 has executed steps S101 to S108 before executing step S201. Further, it is assumed that, at the time when the controller 26 executes step S201, the setting contents of the setting item manually set in a semi-automatic way have been stored as the default setting contents of the setting item in question.

In step S201, the controller 26 determines whether or not an operation to press the automatic setting button 103d has been performed on the touch panel display 31. If it is determined that no such operation has been performed on the touch panel display 31, the controller 26 executes step S203. Meanwhile, if it is determined that such an operation has been performed on the touch panel display 31, the controller 26 executes step S202.

In step S202, the controller 26 performs automatic setting for the setting contents of the setting item which is not the setting item manually set in a semi-automatic way, but is the setting item selected as the automatic setting item.

In step S203, the controller 26 determines whether or not an operation to press the scan start button 103f has been performed on the touch panel display 31. If it is determined that no such operation has been performed on the touch panel display 31, the controller 26 executes step S203 again. Meanwhile, if it is determined that such an operation has been performed on the touch panel display 31, the controller 26 executes step S204.

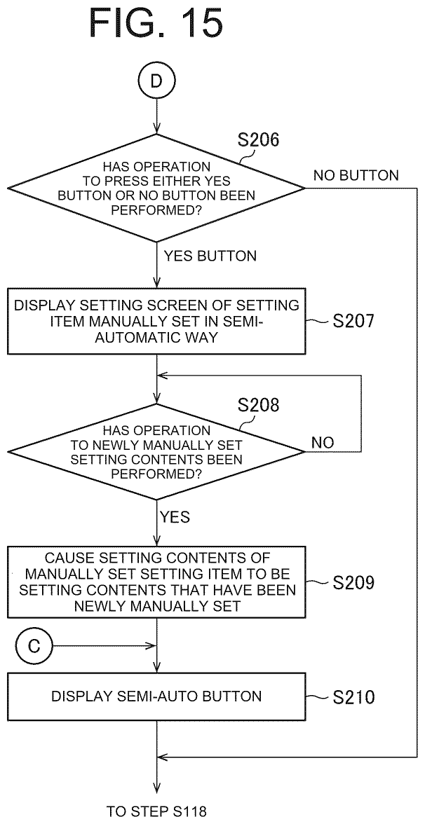

In step S204, the controller 26 determines whether or not there exists setting contents that have been manually set in a semi-automatic way among the default setting contents. If it is determined that there exists no setting contents that have been manually set in a semi-automatic way among the default setting contents, the controller 26 executes step S210 exemplified in FIG. 15. Meanwhile, if it is determined that there exists setting contents that have been manually set in a semi-automatic way among the default setting contents, the controller 26 executes step S205.

In step S205, the controller 26 causes the touch panel display 31 to display the screen 107 such that the screen 107 overlaps the setting screen 103 of the scan mode. The screen 107 makes an inquiry about whether or not to use the setting contents that have been manually set in a semi-automatic way among the default setting contents. Then, the controller 26 executes step S206 exemplified in FIG. 15.

FIG. 15 is a flowchart showing an example of a flow of processing performed by the controller 26 subsequent to FIG. 14.

In step S206, the controller 26 determines whether an operation to press either the YES button 107a or the NO button 107b has been performed on the touch panel display 31. If it is determined that an operation to press the NO button 107b has been performed on the touch panel display 31, the controller 26 executes step S118 exemplified in FIG. 11. Meanwhile, if it is determined that an operation to press the YES button 107a has been performed on the touch panel display 31, the controller 26 executes step S207.

In step S207, the controller 26 causes the touch panel display 31 to display the setting screen 105 of the setting item manually set in a semi-automatic way such that the setting screen 105 overlaps the setting screen 103 of the scan mode. In step S208, the controller 26 determines whether or not an operation to newly manually set the setting contents has been performed on the touch panel display 31. If it is determined that such an operation has been performed on the touch panel display 31, the controller 26 executes step S209. If it is determined that no such operation has been performed on the touch panel display 31, the controller 26 executes step S208 again. In step S209, the controller 26 causes the setting contents of the setting item manually set in a semi-automatic way to be the setting contents that have been newly manually set. That is, when the third operation, which instructs that manual setting should be started for an object to be operated indicating the manually set setting item, is performed on the touch panel display 31, the controller 26 allows the setting contents of the setting item indicated by the object to be operated for which the third operation is performed to be changed by the manual setting.

In step S210, the controller 26 ends the display of the automatic setting button 103d on the touch panel display 31 and causes the touch panel display 31 to display the semi-auto button 103e. Then, the controller 26 executes step S118 exemplified in FIG. 11.

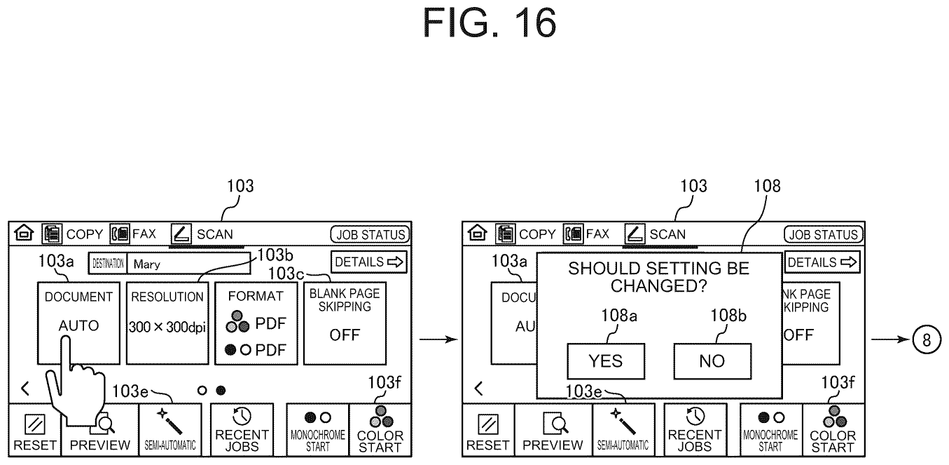

FIGS. 16 to 18 are diagrams illustrating an example of a transition of a screen that the controller 26 causes the touch panel display 31 to display when the controller 26 manually sets the setting contents of the “document” after manually setting the setting contents of the “resolution” in a semi-automatic way.

When the controller 26 has manually set the setting contents of the “resolution” in a semi-automatic way and the resolution “300×300 dpi” is set, the controller 26 causes the resolution button 103b to display the character string “300×300 dpi” indicating the resolution “300×300 dpi”. In that case, as illustrated on the left side of FIG. 16, when an operation to press the document button 103a is performed on the touch panel display 31, the controller 26 causes, as illustrated on the right side of FIG. 16, the touch panel display 31 to display a screen 108 such that the screen 108 overlaps the setting screen 103 of the scan mode. The screen 108 makes an inquiry about whether or not to change the default setting contents and manually set the setting contents of the “document”. The screen 108 includes a YES button 108a and a NO button 108b.

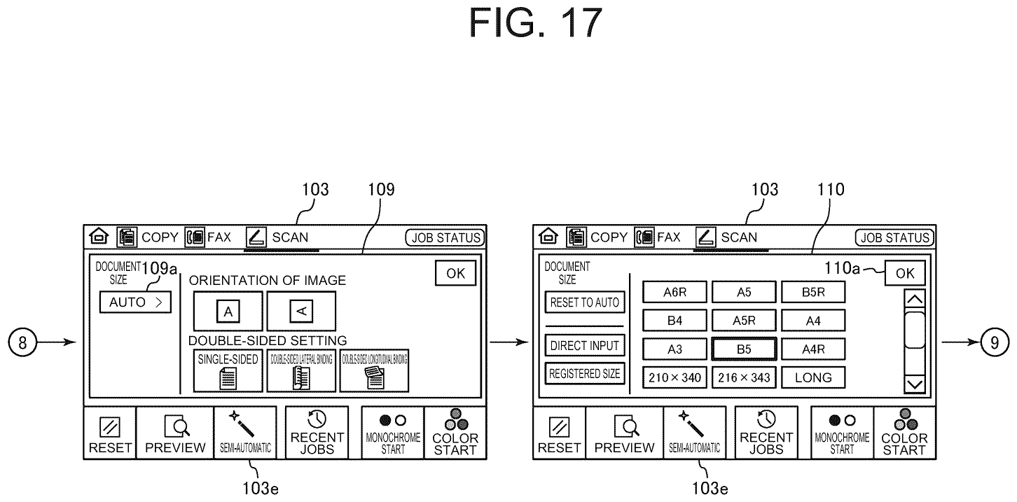

When an operation to press the YES button 108a is performed on the touch panel display 31, the controller 26 causes, as illustrated on the left side of FIG. 17, the touch panel display 31 to display a setting screen 109 of the “document” such that the setting screen 109 overlaps the setting screen 103 of the scan mode. The setting screen 109 of the “document” is used for an operation to set whether to read an image on both sides of the document or only one side of the document, and to set the orientation of the image on the document. The setting screen 109 of the “document” includes a call button 109a.

When an operation to press the call button 109a is performed on the touch panel display 31, the controller 26 ends the display of the setting screen 109 of the “document” on the touch panel display 31, and causes the touch panel display 31 to display the called setting screen 110 of the “document” such that the setting screen 110 overlaps the setting screen 103 of the scan mode, as illustrated on the right side of FIG. 17. The setting screen 110 of the “document” is used for an operation to set the document size and the document orientation. The setting screen 110 of the “document” includes an OK button 110a.

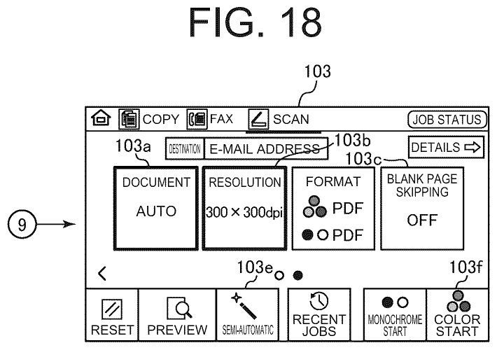

After an operation to set the size of the document to “B5” has been performed on the touch panel display 31, when an operation to press the OK button 110a is performed on the touch panel display 31, the controller 26 ends the display of the setting screen 110 of the “document” on the touch panel display 31 as illustrated in FIG. 18. Also, the controller 26 sets the setting contents of the “document” to “B5” as the size. Further, the controller 26 updates the setting screen 103 of the scan mode. In doing so, the controller 26 displays the character string “B5” indicating the size “B5” in the document button 103a of the setting screen 103 of the scan mode. That is, the controller 26 can change the setting contents of two or more automatically set setting items by the manual setting.

As described above, after manual setting of the setting contents of the setting item has been performed in a semi-automatic way, the image reading device 11 receives an operation to manually set the setting contents of another setting item. That is, the image reading device 11 receives an operation to manually set the setting contents of two or more setting items in a semi-automatic way. Accordingly, the image reading device 11 can easily perform semi-automatic setting of manually setting the setting contents of at least one setting item and causing the setting contents of the remaining setting items to be automatically set.

### Modifications

In the first embodiment, in step S122, the controller 26 stores the setting contents that have been manually set in a semi-automatic way in association with the user, and causes the manually set setting contents of the selected setting item to be the setting contents stored in association with the user.

In contrast, in a modification of the first embodiment, in step S122, the controller 26 stores the setting contents that have been manually set in a semi-automatic way in association with a group to which the user belongs, and causes the setting contents to be those stored in association with the group to which the user belongs. The associated group is the group to which the user, who is involved when the second operation to manually set the setting contents of the automatically set setting item is performed on the touch panel display 31, belongs, that is, the group to which the user identified in step S101 belongs. An administrator of the multifunction peripheral 1 can make the setting of the functional contents of the multifunction peripheral 1 and create a group, and can make the setting of the automatic setting for each group.

The processes executed in the above embodiments are not limited to the processing modes exemplified in the embodiments. The above-described functional blocks may be implemented by using either a logic circuit (hardware) formed in an integrated circuit or the like or software using a CPU. Each of the processes executed in the above embodiments may be executed by a plurality of computers. For example, in the processes executed by the respective functional blocks of the image reading device 11, a part of the processes may be executed by another computer, or all of the processes may be respectively allocated to and executed by a plurality of computers.

The present disclosure is not limited to the above-described embodiments, and may be replaced with a configuration which is substantially the same as the configuration indicated in the above-described embodiments, a configuration which exhibits the same effects and advantages, or a configuration which can achieve the same object. In the present disclosure, an embodiment obtained by combining, as appropriate, technical measures respectively disclosed in different embodiments is also included in the technical scope of the present disclosure. Furthermore, a new technical feature can be formed by combining the technical measures respectively disclosed in the embodiments.

Moreover, each functional block or various features of the device used in the embodiments described above may be implemented in or executed by an electric circuit, such as a single integrated circuit or a plurality of integrated circuits. The electric circuit designed to execute the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may be a microprocessor or, alternatively, a conventional processor, a controller, a microcontroller, or a state machine. The above-described electric circuit may be configured by a digital circuit or by an analog circuit. Moreover, when a technology for forming an integrated circuit which could substitute for the current integrated circuits emerges as a result of the progress of the semiconductor technology, one or more aspects of the present disclosure may also use new integrated circuits based on such technology.

What is claimed is:

1. An image reading device comprising:
an image reader which reads an image in accordance with setting contents of a plurality setting items;
an operation receiver;
a display; and
a controller, wherein
the controller:
automatically sets, when a first operation which instructs that setting contents of at least one setting item among the setting contents of the plurality of setting items be automatically set is performed on the operation receiver, the setting contents of the at least one setting item;
allows, when a second operation to manually set the setting contents of the automatically set setting item is performed on the operation receiver, the setting contents of the automatically set setting item to be changed by manual setting; and
causes, when the setting contents of the automatically set setting item are changed by the manual setting, the display to notify that the setting contents of the automatically set setting item are changed by the manual setting.

2. The image reading device according to claim 1, wherein
the controller changes, when automatic setting is performed for the setting contents of the at least one setting item, a display form of an object to be operated indicating the automatically set setting item.

3. The image reading device according to claim 1, wherein:
the operation receiver comprises a touch panel display; and
when a third operation, which instructs that the manual setting be started for an object to be operated indicating the automatically set setting item, is performed on the touch panel display, the controller allows the second operation to be received on the touch panel display.

4. The image reading device according to claim 1, wherein
the controller stores the setting contents of the manually set setting item, and causes the setting contents of the at least one setting item to be the stored setting contents.

5. The image reading device according to claim 1, wherein
the controller stores the setting contents of the manually set setting item in association with a user involved in storing the setting contents of the manually set setting item, and causes the setting contents of the at least one setting item to be the setting contents stored in association with the user involved when the second operation is performed on the operation receiver.

6. The image reading device according to claim 1, wherein
the controller stores the setting contents of the manually set setting item in association with a group to which a user involved in storing the setting contents of the manually set setting item belongs, and causes the setting contents of the at least one setting item to be the setting contents stored in association with the group to which the user involved when the second operation is performed belongs.

7. The image reading device according to claim 3, wherein
when the third operation is performed on the touch panel display for an object to be operated indicating the manually set setting item, the controller allows the setting contents of the setting item indicated by the object to be operated for which the third operation is performed to be changed by the manual setting.

8. The image reading device according to claim 1, wherein
the at least one setting item is two or more setting items.
